(19) United States
(12) Patent Application Publication
(10) Pub. No.: US 2024/0411241 A1
(43) Pub. Date: Dec. 12, 2024

(54) IMAGE FORMING APPARATUS

(71) Applicant: KYOCERA Document Solutions Inc., Osaka (JP)

(72) Inventor: Takeo MIZOBE, Osaka-shi (JP)

(73) Assignee: KYOCERA Document Solutions Inc., Osaka (JP)

(21) Appl. No.: 18/676,415

(22) Filed: May 28, 2024

(30) Foreign Application Priority Data
Jun. 7, 2023 (JP) 2023-094125

(51) Int. Cl. G03G 15/08; G03G 9/08

(52) U.S. Cl. CPC G03G 15/0812; G03G 9/0819; G03G 15/0818; G03G 2215/0614

(57) ABSTRACT

An image forming apparatus includes a non-magnetic one-component developer, an image bearing member, and a development device that develops an electrostatic latent image formed on a surface of image bearing member by supplying non-magnetic one-component developer to the electrostatic latent image. Development device includes a development roller that carries non-magnetic one-component developer and a restricting member that restricts the thickness of a development layer constituted by non-magnetic one-component developer. Non-magnetic one-component developer contains a positively chargeable toner containing toner particles that include toner mother particles and external additive particles attached to the surfaces of toner mother particles and including resin particles and silica particles. When toner undergoes ultrasonic treatment that involves applying ultrasonic vibration at a frequency of 28 kHz and an output of 100 W for 5 minutes, resin particles and silica particles have detachment fractions within a range of 18% to 42%, and 5% to 25%, respectively.

### INCORPORATION BY REFERENCE

The present application claims priority of Japanese Patent Application No. 2023-094125 under 35 U.S.C. § 119, filed on Jun. 7, 2023. The contents of this application are incorporated herein by reference in their entirety.

### BACKGROUND

The present disclosure relates to an image forming apparatus.

Image forming apparatuses that adopts the electrophotographic method are equipped with, for example, a development device including a development roller that carries a developer and a restricting member that restricts the thickness of a developer layer (toner layer) constituted by the developer on the development roller. There are two types of developers: one-component developers, which contain only a toner, and two-component developers, which contain both toner and a carrier.

Examples of the one-component developers include magnetic one-component developers in which toner particles contain a magnetic powder, and non-magnetic one-component developers in which toner particles do not contain a magnetic powder. In development device that adopts a development method using a non-magnetic one-component developer, the restricting member is provided in the development device so as to contact the surface of the development roller. In the following, a development method with a non-magnetic one-component developer used in a development device where a restricting member is provided in contact with the surface of a development roller may be referred to as a “non-magnetic one-component developer development method”.

The non-magnetic one-component developer development method may lead to a phenomenon where the toner particles adhere to the restricting member during image formation. The non-magnetic one-component developer development method may also result in a phenomenon where external additives detached from the toner particles remain on the contact point between the restricting member and the development roller. These phenomena may serve as a cause of image defects, particularly white streaks and uneven image density.

A method for inhibiting the phenomenon of toner particles adhering to a restricting member is proposed in which a toner containing resin particles and silica particles as external additive particles is used as a non-magnetic one-component developer, for example.

### SUMMARY

An image forming apparatus according to the present disclosure includes a non-magnetic one-component developer, an image bearing member, and a development device that develops an electrostatic latent image formed on the image bearing member by supplying the non-magnetic one-component developer to the electrostatic latent image. The development device includes a development roller that carries the non-magnetic one-component developer and a restricting member that restricts the thickness of a development layer constituted by the non-magnetic one-component developer. The development device is configured to supply the non-magnetic one-component developer to the electrostatic latent image while forming the development layer by allowing the restricting member to contact with the development roller. The non-magnetic one-component developer contains a positively chargeable toner containing toner particles. The toner particles each include a toner mother particle and external additive particles attached to a surface of the toner mother particle. The external additive particles include resin particles and silica particles. When the toner undergoes an ultrasonic treatment that involves applying ultrasonic vibration at a frequency of 28 kHz and an output of 100 W for 5 minutes, the resin particles have a detachment fraction of at least 18% by mass and no greater than 42% by mass and the silica particles have a detachment fraction of at least 5% by mass and no greater than 25% by mass.

### BRIEF DESCRIPTION OF THE DRAWINGS

FIG. 1 is a schematical cross-sectional view of an example of toner particles included in an image forming apparatus according to the present disclosure.

FIG. 2 is a diagram illustrating an example of an image forming apparatus according to the present disclosure.

FIG. 3 is a diagram illustrating the configuration of a development device equipped in the image forming apparatus of FIG. 2.

FIG. 4 is a schematical cross-sectional view of the configuration of a development roller equipped in the image forming apparatus of FIG. 2.

### DETAILED DESCRIPTION

The following first describes the meanings of terms and measurement methods used in this specification. A toner is a collection (e.g., a powder) of toner particles. An external additive is a collection (e.g., a powder) of external additive particles. Unless otherwise stated, values indicating shape or physical properties for a powder (specific examples include a powder of toner particles and a powder of external additive particles) are number averages of values as measured for a suitable number of particles selected from the powder. The “main component” of a material means a component most abundant in the material in terms of mass unless otherwise stated. The term “-based” may be appended to the name of a chemical compound to form a generic name encompassing both the chemical compound itself and derivatives thereof. The term “(meth)acryl” is used as a generic term for both acryl and methacryl. Each component described in this specification may be used alone or in combination of two or more. The expression “at least one of A and B” is synonymous with “A and/or B”.

The volume median diameter (D₅₀) of a powder is a median diameter as measured using a laser diffraction/scattering type particle size distribution analyzer (“LA-950”, product of HORIBA, Ltd.) unless otherwise stated. Unless otherwise stated, the number average primary particle diameter is a number average value of equivalent circle diameters of primary particles (Heywood diameters: diameters of circles having the same areas as projected areas of the primary particles) as measured using a scanning electron microscope. The number average primary particle diameter of a powder is a number average value of equivalent circle diameters of 100 primary particles of the powder, for example. Unless otherwise stated, the amount of charge (unit: μC/g) is a value as measured using a compact suction-type charge measuring device (“MODEL 212HS”, product of TREK, INC.) at a temperature of 25° C. and a relative humidity of 50%. Unless otherwise stated, the softening point (Tm) is a value measured using a capillary rheometer (e.g., “CFT-500D”, product of Shimadzu Corporation). In the S-curve (horizontal axis: temperature, vertical axis: stroke) plotted using the capillary rheometer, the temperature corresponding to a stroke value of “(baseline stroke value+maximum stroke value)/2” corresponds to the softening point (Tm). The above has provided descriptions of the terms and measurement methods used in the present specification.

### <Image Forming Apparatus>

An embodiment of the present disclosure relates to an image forming apparatus. The image forming apparatus of the present embodiment includes a non-magnetic one-component developer, an image bearing member, and a development device that develops an electrostatic latent image formed on the image bearing member by supplying the non-magnetic one-component developer to the electrostatic latent image. The development device includes a development roller that carries the non-magnetic one-component developer and a restricting member that restricts the thickness of a development layer constituted by the non-magnetic one-component developer. The development device is configured to supply the non-magnetic one-component developer to the electrostatic latent image while forming the development layer by allowing the restricting member to contact with the development roller. The non-magnetic one-component developer contains a positively chargeable toner containing toner particles. The toner particles each include a toner mother particle and external additive particles attached to a surface of the toner mother particle. The external additive particles include resin particles and silica particles. When the toner undergoes an ultrasonic treatment that involves applying ultrasonic vibration at a frequency of 28 kHz and an output of 100 W for 5 minutes, the resin particles have a detachment fraction of at least 18% by mass and no greater than 42% by mass and the silica particles have a detachment fraction of at least 5% by mass and no greater than 25% by mass.

Specifically, for measurement of the detachment fraction of the resin particles, a toner dispersion containing 2 parts by mass of a nonionic surfactant (e.g., TRITON (registered Japanese trademark)-X100), 98 parts by mass of water, and 2 parts by mass of the toner undergoes an ultrasonic treatment that involves applying ultrasonic vibration at a frequency of 28 kHz and an output of 100 W for 5 minutes. Next, letting a mass M_{1R} be the mass of the resin particles contained in the toner particles before the ultrasonic treatment and letting a mass M_{2R} be the mass of the resin particles detached from the toner mother particles after the ultrasonic treatment, a percentage (100×M_{2R}/M_{1R}) of the mass M_{2R} to the mass M_{1R} is then calculated. The mass M_{1R} and the mass M_{2R} can be determined by GC/MS analysis, for example. Other detailed measurement conditions can be determined by the method described in Examples or in accordance with the method.

For measurement of the detachment fraction of the silica particles, a toner dispersion containing 2 parts by mass of a nonionic surfactant (e.g., TRITON (registered Japanese trademark)-X100), 98 parts by mass of water, and 2 parts by mass of a toner undergoes an ultrasonic treatment that involves applying the ultrasonic vibration at a frequency of 28 kHz and an output of 100 W for 5 minutes. Next, letting a mass M_{1S} be the mass of the silica particles contained in the toner particles before the ultrasonic treatment and letting a mass M_{2S} be the mass of the silica particles detached from the toner mother particles after the ultrasonic treatment, a percentage (100×M_{2S}/M_{1S}) of the mass M_{2S} to the mass M_{1S} is then calculated. The mass M_{1S} and the mass M_{2S} can be determined by X-ray fluorescence that detects silicon atoms, for example. Other detailed measurement conditions can be determined by the method described in Examples or in accordance with the method.

By having the configuration described above, the image forming apparatus of the present embodiment can inhibit the occurrence of white streaks and uneven image density. The reasons for this are inferred to be as follows. The toner (non-magnetic one-component developer) included in the image forming apparatus of the present embodiment contains silica particles and resin particles as the external additive particles.

The silica particles impart excellent fluidity to toner particles and perform a function of inhibiting the toner particles from attaching to other members (especially the restricting member). The resin particles function as spacer particles that inhibit the silica particles from becoming embedded in the toner mother particles. The silica particles function effectively by the external additive particles containing the resin particles. In addition, in the image forming apparatus of the present embodiment, the resin particles and the silica particles have optimized detachment fractions.

Specifically, the resin particles with a detachment fraction of at least 18% by mass readily act as spacer particles and effectively inhibits the silica particles from becoming embedded in the toner mother particles. Accordingly, the silica particles can further effectively perform the function of inhibiting the toner particles from attaching to other members (especially the restricting member). A detachment fraction of at least 5% by mass for silica particles can ensure sufficient fluidity of the toner, resulting in the uniform thickness of a development layer formed on the development roller. As a result, the image forming apparatus of the present embodiment can inhibit the occurrence of white streaks. The resin particles can be inhibited from detaching from the toner mother particles by having a detachment fraction of no greater than 42% by mass. The silica particles can be inhibited from detaching from the toner mother particles by having a detachment fraction of no greater than 25% by mass. As a result, the occurrence of the phenomenon, where the resin particles and the silica particles detached from the toner mother particles remain on the contact point between the restricting member and the development roller, can be inhibited. Thus, the image forming apparatus of the present embodiment can inhibit the occurrence of uneven image density. The following describes the details of the toner used in the image formation apparatus of the present embodiment followed by a detailed description of the devices included in the image forming apparatus.

### [Toner Particles]

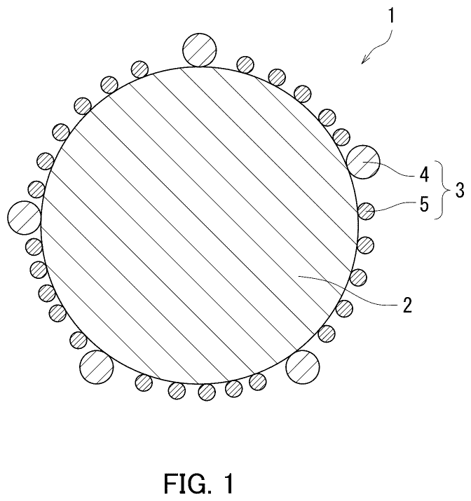

The toner is positively chargeable toner that contains toner particles. The following describes an example of the toner particles with reference to FIG. 1. FIG. 1 illustrates a toner particle 1 that is an example of the toner particles. The toner particle 1 in FIG. 1 includes a toner mother particle 2, and external additive particles 3 attached to the surface of the toner mother particle 2. The external additive particles 3 include resin particles 4 and silica particles 5.

Description of toner particles has been made with reference to FIG. 1. However, the toner particles may have different structure from the toner particle 1 in FIG. 1. For example, the toner particles may be toner particles (also referred to below as capsule toner particles) that include a shell layer. The capsule toner particles each include a toner mother particle that includes, for example, a toner core containing a binder resin and a shell layer covering a part of the surface of the toner core. In addition, the external additive particles may include optional particles other than the resin particles and the silica particles. The above has described the toner particles in detail with reference to FIG. 1.

### [External Additive Particles]

The external additive particles are attached to the surfaces of the toner mother particles. The external additive particles include resin particles and silica particles.

### (Resin Particles)

Examples of the resin contained in the resin particles includes (meth)acrylic resins, styrene-(meth)acrylic resins, polyester resins, polyurethane resins, and olefin resins (e.g., polyethylene resins and polypropylene resin). The resin contained in the resin particles preferably are cross-linked. The resin contained in the resin particles is preferably styrene-(meth)acrylic resin, and more preferably cross-linked styrene-(meth)acrylic resin. The styrene-(meth)acrylic resin in the resin particles has a percentage content of preferably at least 70% by mass, more preferably at least 95% by mass, and further preferably 100% by mass.

The styrene-(meth)acrylic resin is a copolymer of a styrene compound and a (meth)acrylic acid compound. Examples of the (meth)acrylic acid compounds include (meth)acrylic acid, (meth)acrylonitrile, and (meth)acrylic acid alkyl esters (especially (meth)acrylic acid alkyl esters having an alkyl group with a carbon number of at least 1 and no greater than 4 in its ester moiety).

The styrene-(meth)acrylic resin preferably includes a first repeating unit derived from a styrene compound and a second repeating unit derived from a (meth)acrylic acid alkyl ester.

Examples of the styrene compounds include styrene, alkylstyrenes (specific examples include α-methylstyrene, o-methylstyrene, m-methylstyrene, p-methylstyrene, ethylstyrene, 2,3-dimethylstyrene, 2,4-dimethylstyrene, o-tert-butylstyrene, m-tert-butylstyrene, and p-tert-butylstyrene), and halogenated styrenes (specific examples include α-chlorostyrene, o-chlorostyrene, m-chlorostyrene, and p-chlorostyrene). The styrene compound is preferably styrene.

The first repeating unit has a percentage content of preferably at least 4.0% by mass and no greater than 25.0% by mass to all repeating units in the styrene-(meth)acrylic resin, and more preferably at least 6.0% by mass and no greater than 14.0% by mass.

Examples of the (meth)acrylic acid alkyl ester include methyl (meth)acrylate, ethyl (meth)acrylate, n-propyl (meth)acrylate, iso-propyl (meth)acrylate, butyl (meth)acrylate (specifically, n-butyl (meth)acrylate), iso-butyl (meth)acrylate, and 2-ethylhexyl (meth)acrylate. The (meth)acrylic acid alkyl ester is preferably butyl (meth)acrylate.

The second repeating unit has a percentage content of preferably at least 30.0% by mass and no greater than 95.0% by mass to all the repeating units in the styrene-(meth)acrylic resin, and more preferably at least 45.0% by mass and no greater than 60.0% by mass.

The styrene-(meth)acrylic resin further include a third repeating unit derived from a cross-linking agent when it undergoes cross-linking. The resin particles are imparted with adequate rigidity by containing the cross-linked styrene-(meth)acrylic resin, thereby facilitating their function as spacer particles.

The cross-linking agent is, for example, a compound with two or more vinyl groups. Specific examples of the crosslinking agent include N,N′-methylenebisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate, and 1,6-hexanediol dimethacrylate. The cross-linking agent is preferably divinylbenzene.

The third repeating unit has a percentage content of preferably at least 20.0% by mass and no greater than 45.0% by mass to all the total repeating units in styrene-(meth)acrylic resin, and more preferably at least 32.0% by mass and no greater than 40.0% by mass. When the third repeating unit has a percentage content of at least 20.0% by mass, the resin particles are optimized for rigidity, which further facilitates their function as spacer particles. When the third repeating unit has a percentage content of no greater than 45.0% by mass, it is possible to inhibit the surface of the photosensitive member from being polished due to excessively high hardness of the resin particles.

The styrene-(meth)acrylic resin is preferably a resin containing the repeating units of Combination 1 or 2 as follows. Note that, in Combination 1 and 2, the numerical range shown in parentheses after a repeating unit indicates the preferred percentage content of the repeating unit to all repeating units.
Combination 1: a repeating unit (e.g., at least 8.0% by mass and no greater than 13.0% by mass) derived from styrene, a repeating unit (e.g., at least 50.0% by mass and no greater than 55.0% by mass) derived from n-butyl methacrylate, and a repeating unit (e.g., at least 34.0% by mass and no greater than 40.0% by mass) derived from divinylbenzene.
Combination 2: a repeating unit (e.g., at least 8.0% by mass and no greater than 12.0% by mass) derived from styrene and a repeating unit (e.g., at least 88.0% by mass and no greater than 92.0% by mass) derived from methyl methacrylate.

The resin particles have a detachment fraction of preferably at least 18% by mass and no greater than 42% by mass, and more preferably at least 25% by mass and no greater than 35% by mass. The resin particles with a detachment fraction of at least 18% by mass can reliably function as spacer particles. The resin particles with a detachment fraction of no greater than 42% by mass can be inhibited from detaching from the toner mother particles.

The detachment fraction of the resin particles can be adjusted primarily based on the content of the resin particles in the toner particles, the conditions (e.g., stirring speed and time for external additive addition) for external additive addition of resin particles to toner mother particles, and the number average primary particle diameter of the resin particles. Specifically, the resin particles having a higher content in toner particles have a greater detachment fraction. A higher stirring speed makes the resin particles firmly attached to the toner mother particles, reducing the detachment fraction of the resin particles. Longer time for external additive addition makes the resin particles firmly attached to the toner mother particles, reducing the detachment fraction of the resin particles. The resin particles with a larger number average primary particle diameter have a greater detachment fraction.

The resin particles have a number average primary particle diameter of preferably at least 30 nm and no greater than 130 nm, more preferably at least 50 nm and no greater than 100 nm, and further preferably at least 70 nm and no greater than 90 nm. The resin particles readily act as the spacer particles by having a number average primary particle diameter of at least 30 nm. The resin particles can be further effectively inhibited from detaching from the toner mother particles by having a number average primary particle diameter of no greater than 130 nm.

From the viewpoint of fully demonstrating the function of the resin particles while inhibiting their detachment from the toner mother particle, the content of the resin particles in the toner particles is preferably at least 0.1 parts by mass and no greater than 4.0 parts by mass relative to 100 parts by mass of the toner mother particles, more preferably at least 0.2 parts by mass and no greater than 1.3 parts by mass, further preferably at least 0.5 parts by mass and no greater than 1.0 part by mass, and particularly preferably at least 0.7 parts by mass and no greater than 1.0 part by mass. The resin particles readily act as the spacer particles when they have a content of at least 0.1 parts by mass. The resin particles are more effectively inhibited from detaching from the toner mother particle when they have a content of no greater than 4.0 parts by mass.

The resin particles can be produced, for example, by emulsion polymerization of monomers (e.g., a styrene compound, a (meth)acrylic acid compound, and a cross-linking agent), which are raw materials, in the presence of an ionic surfactant (emulsifier). Examples of a polymerization initiator used in emulsion polymerization include benzoyl peroxide and 2,2′-azobis(2-amidinopropane) dihydrochloride. For example, the amount of the ionic surfactant used is at least 1 part by mass and no greater than 5 parts by mass relative to 100 parts by mass of the monomers, which are the raw materials. For example, the amount of the polymerization initiator used is at least 4 parts by mass and no greater than 12 parts by mass relative to 100 parts by mass of the monomers, which are the raw materials.

### (Ionic Surfactant)

Preferably, the toner particles further contain an ionic surfactant attached to the surfaces of the resin particles. The ionic surfactant is derived from the ionic surfactant used in the production of the resin particles. The ionic surfactant adjusts the charging performance of toner particles. Examples of the ionic surfactant include a cation surfactant and an anion surfactant. The ionic surfactant is preferably a cation surfactant.

The cation surfactant is alkyltrimethylammonium salt having an alkyl group with a carbon number of at least 10 and no greater than 25, for example. A specific cation surfactant is preferably a cetyltrimethylammonium salt, and more preferably cetyltrimethylammonium chloride.

The anion surfactant is alkyl benzene sulfonate having an alkyl group with a carbon number of at least 10 and no greater than 25, for example. A specific anion surfactant is preferably a dodecylbenzene sulfonate salt, and more preferably sodium dodecylbenzene sulfonate.

### (Silica Particles)

The silica particles impart fluidity to the toner particles. The silica particles are preferably subjected to a surface treatment for imparting positive chargeability. The silica particles have a number average primary particle diameter of preferably at least 10 nm and no greater than 100 nm, more preferably at least 15 nm and no greater than 50 nm, and further preferably at least 15 nm and no greater than 30 nm. The silica particles with a number average primary particle diameter of at least 10 nm can be further effectively inhibited from becoming embedded in the toner mother particles. The silica particles with a number average primary particle diameter of no greater than 100 nm can be further effectively inhibited from detaching from the toner mother particles.

The silica particles have a detachment fraction of at least 5% by mass and no greater than 25% by mass, and preferably at least 7% by mass and no greater than 15% by mass. A detachment fraction of the silica particles of at least 5% by mass can provide the toner particles with sufficient fluidity. As a result, the image forming apparatus of the present embodiment can ensure uniform thickness of the development layer formed with the developer on the development roller. The silica particles with a detachment fraction of no greater than 25% by mass can be inhibited from detaching from the toner mother particles.

The detachment fraction of the silica particles can be adjusted primarily based on the content of the silica particles in the toner particles, the conditions (e.g., stirring speed and time for external additive addition) for external additive addition of the silica particles to the toner mother particles, and the number average primary particle diameter of the silica particles. Specifically, the silica particles having a higher content in toner particles have a greater detachment fraction. A higher stirring speed makes the silica particles firmly attached to the toner mother particles, reducing the detachment fraction of the silica particles. Longer time for external additive addition makes the silica particles firmly attached to the toner mother particles, reducing the detachment fraction of the silica particles. The silica particles with a larger number average primary particle diameter have a greater detachment fraction.

From the viewpoint of fully demonstrating the function of the silica particles while inhibiting their detachment from the toner mother particles, the content of the silica particles in the toner particles is preferably at least 0.1 parts by mass and no greater than 15.0 parts by mass relative to 100 parts by mass of toner mother particles, and more preferably at least 1.0 part by mass and no greater than 3.0 parts by mass.

### (Optional External Additive Particles)

The external additive may further include optional external additive particles other than the resin particles and silica particles. Examples of the optional external additive particles include particles of metal oxides (specifical examples include alumina, magnesium oxide, and zinc oxide), and particles of organic acid compounds such as fatty acid metal salts (specifically, zinc stearate).

### (Toner Mother Particles)

The toner mother particles contain, for example, a binder resin as a main component. The toner mother particles may further contain an internal additive (e.g., at least one of a colorant, a releasing agent, a charge control agent, and a magnetic powder) as necessary. Examples of methods for producing the toner mother particles include a pulverization method and an aggregation method, the pulverization method is preferable.

### (Binder Resin)

From the viewpoint of providing toners with low temperature fixability, the toner mother particles preferably contain a thermoplastic resin as the binder resin, and more preferably contain the thermoplastic resin with a content of at least 85% by mass of the total binder resin. Examples of the thermoplastic resin include styrene resins, acrylic ester resins, olefin resins (e.g., polyethylene resins and polypropylene resin), and vinyl resins (e.g., vinyl chloride resin, polyvinyl alcohol, vinyl ether resin, and N-vinyl resin), polyester resins, polyamide resins, and urethane resins. A copolymer of any of these resins, that is, a copolymer (e.g., styrene-acrylic ester resins and styrene-butadiene resins) in which any repeating unit is introduced into any of the above resins can also be used as the binder resin.

The binder resin in the toner mother particle has a percentage content of preferably at least 60% by mass and no greater than 95% by mass, and more preferably at least 80% by mass and no greater than 90%.

From the viewpoint of improving low temperature fixability of toners, a polyester resin is preferable as the binder resin. The polyester resin is obtained by condensation polymerization of at least one polyhydric alcohol and at least one polybasic carboxylic acid. Examples of the polyhydric alcohol for synthesizing the polyester resin include dihydric alcohols (e.g., diol compounds and bisphenol compounds) and tri- or higher-hydric alcohols. Examples of the polybasic carboxylic acid for synthesizing polyester resins include dibasic carboxylic acids and tri- or higher-basic carboxylic acids. Note that a polybasic carboxylic acid derivative (e.g., an anhydride of a polybasic carboxylic acid and a halide of a polybasic carboxylic acid) that can form an ester bond by condensation polymerization may be used, instead of the polybasic carboxylic acid.

Examples of the diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-penten-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compounds include bisphenol A, hydrogenated bisphenol A, bisphenol A ethylene oxide adducts (e.g., polyoxyethylene (2,2)-2,2-bis(4-hydroxyphenyl) propane), and bisphenol A propylene oxide adducts.

Examples of tri- or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxy methylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkylsuccinic acids (more specifically, n-butylsuccinic acid, isobutylsuccinic acid, n-octylsuccinic acid, n-dodecylsuccinic acid, and isododecylsuccinic acid), and alkenylsuccinic acids (more specifically, n-butenylsuccinic acid, isobutenylsuccinic acid, n-octenylsuccinic acid, n-dodecenylsuccinic acid, and isododecenylsuccinic acid).

Examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxylpropane, 1,2,4-cyclohexanetricarboxylic acid, tetra(methylenecarboxyl) methane, 1,2,7,8-octane tetracarboxylic acid, pyromellitic acid, and Empol trimer acid.

The polyester resin is preferably a condensation polymer of terephthalic acid, bisphenol A ethylene oxide adduct, and trimellitic acid.

### (Colorant)

The toner mother particles may contain a colorant. The colorant can be a known pigment or dye that matches the color of the toner. From the viewpoint of forming high quality images with the toner, the colorant preferably has a content of at least 1 part by mass and no greater than 20 parts by mass relative to 100 parts by mass of the binder resin, and more preferably at least 2 parts by mass and no greater than 10 parts by mass.

The toner mother particles may contain a black colorant. The black colorant may be carbon black, for example. Alternatively, the black colorant may be a colorant whose color is adjusted to a black color using a yellow colorant, a magenta colorant, and a cyan colorant.

The toner mother particle may contain color colorant. Examples of the color colorant include a yellow colorant, a magenta colorant, and a cyan colorant.

### (Releasing Agent)

The toner mother particles may contain a releasing agent. The releasing agent is used to effectively further inhibit toner offset, for example. The releasing agent has a content of preferably at least 1 part by mass and no greater than 20 parts by mass relative to 100 parts by mass of the binder resin, and more preferably at least 5 parts by mass and no greater than 15 parts by mass.

Examples of the releasing agent include aliphatic hydrocarbon-based waxes, oxides of aliphatic hydrocarbon-based waxes, plant waxes, animal waxes, mineral waxes, ester waxes with a fatty acid ester as a primary component, and waxes in which a fatty acid ester has been partially or fully deoxidized. Examples of the aliphatic hydrocarbon-based waxes include low molecular weight polyethylene, low molecular weight polypropylene, polyolefin copolymers, polyolefin wax, microcrystalline wax, paraffin wax, and Fischer-Tropsch wax. Examples of the oxides of aliphatic hydrocarbon-based waxes include oxidized polyethylene wax and block copolymers of oxidized polyethylene wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes with a fatty acid ester as a primary component include montanic acid ester wax and castor wax. Examples of the waxes in which a fatty acid ester has been partially or fully deoxidized include deoxidized carnauba wax. Carnauba wax is a preferred releasing agent.

When the toner mother particles contain the releasing agent, a compatibilizer may be added to improve the compatibility between the binder resin and the releasing agent.

### (Charge Control Agent)

The toner mother particles may contain a charge control agent. The charge control agent is used to provide a toner with excellent charge stability or excellent charge rise characteristics. The charge rise characteristics of the toner serve as an indicator as to whether or not the toner can be charged to a specific charge level in a short period of time. The toner mother particles can exhibit improved cationic properties by containing a positively chargeable charge control agent.

Examples of the positively chargeable charge control agent include azine compounds, direct dyes, acid dyes, alkoxylated amines, alkylamides, quaternary ammonium salt compounds, and resins with a quaternary ammonium cation group. A quaternary ammonium salt compound is a preferred charge control agent.

Examples of the quaternary ammonium compound include benzyldecylhexylmethyl ammonium chloride, decyltrimethyl ammonium chloride, 2-(methacryloyloxy)ethyltrimethylammonium chloride, and dimethylaminopropylacrylamide methyl chloride quaternary salt.

From the viewpoint of achieving further excellent charge stability in the toner, the charge control agent preferably has a content of at least 1 part by mass and no greater than 10 parts by mass relative to 100 parts by mass of the binder resin, and more preferably at least 1 part by mass and no greater than 5 parts by mass.

### [Toner Production Method]

The toner can be produced by a production method that includes a toner mother particle preparation process and an external additive addition process, for example.

### (Toner Mother Particle Preparation Process)

In the toner mother particle preparation process, the toner mother particles are prepared by a method such as aggregation or pulverization.

The aggregation includes an aggregation process and a coalescence process, for example. In the aggregation process, fine particles containing components constituting the toner mother particles are aggregated in an aqueous medium to form aggregated particles. In the coalescence process, components contained in the aggregated particles are allowed to coalesce in an aqueous medium to form the toner mother particles.

The following describes the pulverization method. The pulverization method can prepare the toner mother particles relatively easily with reduced manufacturing costs. The pulverization method for preparing toner mother particles includes a toner mother particle preparation process that includes melt-kneading and pulverization, for example. The toner mother particle preparation process may further include mixing before the melt-kneading. The toner mother particle preparation process may further include at least one of fine pulverization and classification after the pulverization.

In the mixing, the binder resin and an internal additive added as necessary are mixed to obtain a mixture. In the melt-kneading, a toner material is melted and kneaded to obtain a melt-kneaded product. For example, the mixture obtained in the mixing is used as the toner material. In the pulverization, the resulting melt-kneaded product is cooled to, for example, room temperature (25° C.), and then pulverized to obtain a pulverized product. The pulverized product may undergo further pulverization (fine pulverization) when it is required to reduce its diameter. The resulting pulverized product may be classified (classification) to align the particle size. Through the above processes, a pulverized product of the toner mother particles is obtained.

### (External Additive Addition Process)

In the present process, the external additive particles containing the resin particles and the silica particles are attached to the surfaces of the toner mother particles. A method for attaching the external additive particles to the surfaces of the toner mother particles is, but not limited to, mixing while stirring the toner mother particles and the external additive particles using a mixer. The mixer is an FM mixer (product of Nippon Coke & Engineering Co., Ltd.), for example.

The stirring speed during mixing in the external additive addition process is preferably at least 2000 rpm and no greater than 5000 rpm, and more preferably at least 3000 rpm and no greater than 4000 rpm. The time for external additive addition process is preferably at least 7 minutes and no greater than 38 minutes, and more preferably at least 20 minutes and no greater than 30 minutes.

Note that the present process may be carried out in multiple stages (e.g., two stages). When the present process is carried out in two stages, for example, the toner mother particles and some of the external additive particles are stirred using a mixer or the like in the first round of external additive addition. In the second round of external additive addition, the resulting mixture obtained in the first round of external additive addition and the rest of the external additive particles are stirred using the mixer. As described above, the present process carried out in multiple stages can individually adjust the adhesion of the multiple types of the external additive particles to the toner mother particles.

### [Details of Apparatus]

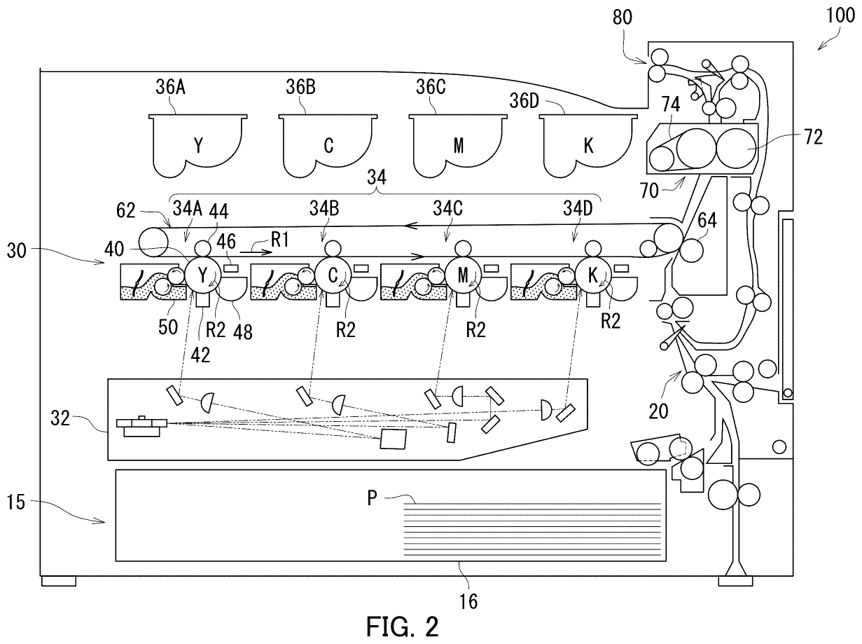

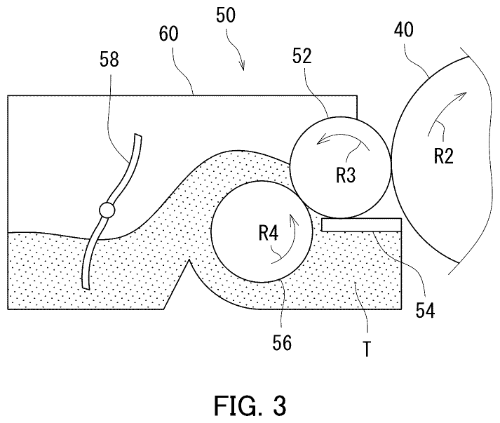

The following describes the configuration other than the toner of the image forming apparatus according to the present embodiment with reference to the drawings. FIG. 2 is a diagram illustrating an example of the configuration of the image forming apparatus according to the present embodiment present embodiment. FIG. 3 is a diagram illustrating the configuration of a development device included in the image forming apparatus in FIG. 2. Note that the reference drawings mainly show each element schematically for ease of understanding, and various aspects of each element in the diagrams, such as size, number, and shape, may differ from their actual aspects for the sake of easy drawing preparation.

As illustrated in FIG. 2, an image forming apparatus 100 is a non-magnetic one-component developer development printer that forms images on sheets P, which serve as a recording medium. The image forming apparatus 100 includes a feed section 15, a conveyance section 20, an image forming section 30, and an ejection section 80.

The feed section 15 is provided with a cassette that accommodates multiple sheets P. The sheets P are sheets of paper or synthetic resin, for example. The feed section 15 feeds the sheets P to the conveyance section 20 one at a time. The conveyance section 20 conveys the sheet P to the image forming section 30. The image forming section 30 forms an image on the sheet P. The conveyance section 20 conveys the sheet P with image formed thereon to the ejection section 80. The ejection section 80 ejects the sheet P out of the image forming apparatus 100.

The image forming section 30 includes a light exposure unit 32, a first toner image generating unit 34A, a second toner image generating unit 34B, a third toner image generating unit 34C, a fourth toner image generating unit 34D, a first toner container 36A, a second toner container 36B, a third toner container 36C, a fourth toner container 36D, an intermediate transfer belt 62, a secondary transfer roller 64, and a fixing device 70. The image forming apparatus 100 is a tandem apparatus, and the first toner image generating unit 34A, the second toner image generating unit 34B, the third toner image generating unit 34C and the fourth toner image generating unit 34D are arranged linearly along the intermediate transfer belt 62.

Note that to avoid redundancy in the following description of the present specification, the first toner image generating unit 34A, the second toner image generating unit 34B, the third toner image generating unit 34C, and the fourth toner image generating unit 34D may be referred to as a toner image generating unit 34A, a toner image generating unit 34B, a toner image generating unit 34C and a toner image generating unit 34D, respectively. Similarly, the first toner container 36A, the second toner container 36B, the third toner container 36C, and the fourth toner container 36D may be referred to as a toner container 36A, a toner container 36B, a toner container 36C and a toner container 36D, respectively.

The light exposure unit 32 irradiates each of the toner image generating units 34A to 34D with light based on image data to form electrostatic latent images thereon.

The toner image generating unit 34A forms a yellow toner image based on a corresponding one of the electrostatic latent images. The toner image generating unit 34B forms a cyan toner image based on a corresponding one of the electrostatic latent images. The toner image generating unit 34C forms a magenta toner image based on a corresponding one of the electrostatic latent images. The toner image generating unit 34D forms a black toner image based on a corresponding one of the electrostatic latent images.

The toner container 36A accommodates a toner for forming yellow toner images. The toner container 36B accommodates a toner for forming cyan toner images. The toner container 36C accommodates a toner for forming magenta toner images. The toner container 36D accommodates a toner for forming black toner images. The toners accommodated in the toner containers 36A to 36D each are the toner (toner T in FIG. 3) described above.

The intermediate transfer belt 62 circulates in the direction of an arrow R1. The toner images in four colors are sequentially transferred to the outer surface of the intermediate transfer belt 62. The secondary transfer roller 64 transfer the toner images formed on the outer surface of the intermediate transfer belt 62 to the sheet P. The fixing device 70 applies heat and pressure to the sheet P to fix the toner images thereto.

The image forming apparatus 100 uses an oilless fusing method that employs no fixing oil application mechanism. The image forming apparatus 100, employing the oilless fusing method, enables downsizing and cost reduction. From the viewpoint of ensuring the fixability, the toner used in the image forming apparatus 100 employing the oilless fusing method is likely to require a relatively large amount of releasing agent. However, for a known toner, the toner particles tend to attach to a restricting blade 54 and a photosensitive drum 40 when increasing the amount of the releasing agent. By contrast, the image forming apparatus 100 includes the aforementioned toner, which contains the silica particles and the resin particles, has an optimized detachment fraction. As a result, the toner included in the image forming apparatus 100 can inhibit the toner particles from adhering to the restricting blade 54 and the photosensitive drum 40.

The outline of the configuration of the image forming apparatus 100 has been described above. The following describes the configuration of the image forming apparatus 100 in detail. Note that, in the following, the toner image generating unit 34A, the toner image generating unit 34B, the toner image generating unit 34C and the toner image generating unit 34D may be each referred to as a toner image generating unit 34, when there is no need to distinguish between them.

The toner image generating unit 34 includes a photosensitive drum 40 as an image bearing member, a charger 42, a development device 50, a primary transfer roller 44, a static eliminator 46, and a cleaner 48. The charger 42, the development device 50, the primary transfer roller 44, the static eliminator 46, and the cleaner 48 of the toner image generating unit 34 are arranged in the stated order along the circumferential surface of the photosensitive drum 40.

The photosensitive drum 40 is placed so as to be in contact with the outer surface of the intermediate transfer belt 62. The primary transfer roller 44 is placed opposite to the photosensitive drum 40 with the intermediate transfer belt 62 therebetween.

The photosensitive drum 40 rotates in the direction of an arrow R2. The charger 42 charges the circumferential surface of the photosensitive drum 40. an electrostatic latent image is formed on the circumferential surface of the photosensitive drum 40 through light irradiation by the light exposure unit 32.

The photosensitive drum 40 can be a photosensitive member with a photosensitive layer containing amorphous silicon or a photosensitive member containing an organic photoconductor, for example.

As illustrated in FIG. 3, the development device 50 includes a development roller 52, a restricting blade 54 (restricting member), a feeding roller 56, a stirring member 58, and a housing 60. The development device 50 supplies a toner T to the electrostatic latent image formed on the circumferential surface of the photosensitive drum 40 and allows the toner T to attach thereto, thereby developing the electrostatic latent images. As a result, a toner image is formed on the circumferential surface of the photosensitive drum 40.

The development roller 52 carries the toner T. The toner T is the aforementioned toner (non-magnetic one-component developer). The toner T is supplied from a corresponding one of the toner containers (anyone of the toner containers 36A to 36D in FIG. 2). The development roller 52 is placed so as to be in contact with the photosensitive drum 40 and is capable of rotating in the direction of an arrow R3 while being rotationally driven, accompanied by the rotation of the photosensitive drum 40. The development roller 52 carries and supplies the toner T to the photosensitive drum 40.

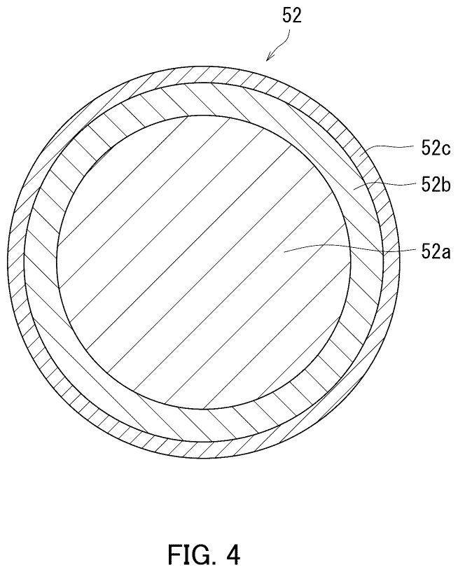

As illustrated in FIG. 4, the development roller 52 preferably includes a conductive base 52a, a silicone rubber layer 52b covering the surface of the conductive base 52a, and a urethane layer 52c covering the surface of the silicone rubber layer 52b. The development roller 52 can be optimized in elasticity when including the silicone rubber layer 52b. The development roller 52 can be optimized in surface resistance when including the urethan layer 52c.

The restricting blade 54 regulates the thickness of a toner layer (not shown) constituted by the toner T. The toner layer is formed on the development roller 52. The restricting blade 54 has an end that is in contact with the circumferential surface of the development roller 52. The restricting blade 54 is a leaf spring that is pressed against the development roller 52 at a specific level of pressure, for example. Examples of the constituent materials of the restricting blade 54 include resins (specific examples include silicone resin and urethane resin), metals (specific examples include stainless steel (SUS), aluminum, copper, brass, and phosphor bronze), and composite materials of these.

SUS is a preferred constituent material of the restricting blade 54. Therefore, the restricting member of the image forming apparatus of the present embodiment is preferably a SUS blade. The SUS blade, which has conductivity and is moderately elastic and easily deformable, can regulate the thickness of the toner layer appropriately. The contact pressure of the restricting blade 54 against the development roller 52 is preferably at least 15 N/m and no greater than 45 N/m, and more preferably at least 35 N/m and no greater than 45 N/m. The restricting blade 54 with a contact pressure of at least 15 N/m can regulate the thickness of the toner layer appropriately. The restricting blade 54 with a contact pressure of no greater than 45 N/m can inhibit excessive friction between the toner T and the development roller 52, thereby ensuring adequate thickness of the toner layer.

The feeding roller 56 supplies the toner T to the development roller 52. The feeding roller 56 is in contact with the development roller 52 and is supported in a manner rotatable in the direction of an arrow R4.

The stirring member 58 stirs the toner T and conveys it to the feeding roller 56. The housing 60 accommodates each member of the development device 50 and the toner T.

The development device 50 is configured to form a toner layer by allowing the restricting blade 54 to contact with the development roller 52, and develop the electrostatic latent image formed on the circumferential surface of the photosensitive drum 40 into a toner image by supplying the toner T (specifically, the toner T contained in the toner layer) to the electrostatic latent image.

The following describes the configuration of the image forming apparatus 100 in detail with further reference to FIG. 2. The primary transfer roller 44 transfers the toner images formed on the circumferential surfaces of the photosensitive drums 40 to the surface of the intermediate transfer belt 62. The static eliminator 46 removes static electricity from the circumferential surface of the photosensitive drum 40 after transfer of the toner image to the intermediate transfer belt 62. The cleaner 48 removes the toner T remained on the circumferential surface of the photosensitive drum 40. The cleaner 48 includes a cleaning blade, for example.

The toner images transferred onto the outer surface of the intermediate transfer belt 62 are transferred to the sheet P by the secondary transfer roller 64. That is, the secondary transfer roller 64 is a transfer section that transfers the toner images formed on the circumferential surfaces of the photosensitive drums 40 to the sheet P via the intermediate transfer belt 62. The sheet P with transferred toner images is conveyed to the fixing device 70 by the conveyance section 20. The fixing device 70 includes a pressure roller 72 and a fixing belt 74, which respectively apply pressure and heat to the toner images transferred to the sheet P. Note that a fixing roller may be used instead of the fixing belt 74. The sheet P conveyed to the fixing device 70 is applied with heat and pressure between the pressure roller 72 and the fixing belt 74. As a result, the toner images (image) are fixed to the sheet P. The sheet P is then ejected out of the image forming apparatus 100 by the ejection section 80. The image forming apparatus 100 forms image on the sheet P as described above.

The image forming apparatus 100, which includes the aforementioned toner as the non-magnetic one-component developer, can inhibit occurrence of white streaks and uneven image density.

The image forming apparatus 100, which is an example of the image forming apparatus of the present embodiment, has been described so far. However, the image forming apparatus of the present embodiment is not limited to the image forming apparatus 100. The image forming apparatus of the present embodiment may be a monochrome image forming apparatus, for example. The monochrome image forming apparatus includes, for example, one toner image generating unit and one toner container. The image forming apparatus of the present embodiment may be an image forming apparatus adopting a direct transfer process. The image forming apparatus adopting a direct transfer process includes a transfer section that directly transfers toner images from the image bearing members to a recording medium. The development roller may have a configuration that differs from the layered configuration in FIG. 4. The restricting member may be a member (e.g., restricting roller) other than the restricting blade.

### Examples

The following describes the present disclosure further in detail using examples. However, the present disclosure is not limited in any way to the scope of the examples.

### [Measurement of Number Average Primary Particle Diameter]

The number average primary particle diameter of each type of particle (resin particles, silica particles, etc.) described in the present examples was measured using a scanning electron microscope (field emission scanning electron microscope, “JSM-7600F”, product of JEOL Ltd.) at a magnification of 3000×. In the measurement of the average primary particle diameter, the equivalent diameters (Haywood diameters: the diameters of circles having the same areas as the projected areas of primary particles) of 100 primary particles were measured, and the number average value thereof was obtained.

### [Ultrasonic Treatment for Toner]

A nonionic surfactant aqueous solution was obtained by mixing 2 parts by mass of a nonionic surfactant (“EMULGEN (registered Japanese trademark) 120”, product of Kao Corporation, component: polyoxyethylene lauryl ether) and 98 parts by mass of ion exchange water. A toner dispersion was obtained by mixing 100 parts by mass of a nonionic surfactant aqueous solution (concentration: 2% by mass) with 2 parts by mass of a toner, which is a measurement target. The resulting toner dispersion underwent an ultrasonic treatment for 5 minutes using an ultrasonic disperser (“ULTRASONIC MINI WELDER P128”, product of Ultrasonic Engineering Co., Ltd., output: 100 W, oscillation frequency: 28 kHz). Subsequently, the ultrasonically treated toner dispersion was suction filtered (suction filtration) using a Buchner funnel and qualitative filter paper (“FILTER PAPER No. 1”, product of Advantech Co., Ltd., pore size of approximately 5 μm). Thereafter, a re-slurry by adding 50 mL of ion exchange water to the residue and the suction filtration described above were repeated three times (washing). Through the washing, the surfactant attached to the surfaces of the toner particles was removed. Subsequent to the washing, the residue together with the filter paper was placed in an aluminum container. The aluminum container was then placed in a vacuum low-temperature dryer and vacuum-dried at 40° C. for 12 hours. This allowed the residue (toner undergone the ultrasonic treatment) to be dried completely. The dried residue was used as an ultrasonically treated measurement sample. A toner without any treatment was separately prepared and used as an untreated measurement sample.

### [Measurement of Detachment Fraction of Resin Particles]

The detachment fraction of resin particles was measured using the ultrasonically treated measurement sample and the untreated measurement sample. The measurement devices used a gas chromatograph mass spectrometer (“GCMS-QP2010 ULTRA” product of Shimadzu Corporation) and a multi-shot pyrolyzer (“PY-3030D”, product of Frontier Laboratories Ltd.). The column used was a GC column (“AGILENT (registered Japanese trademark) J&W ULTRA INERT CAPILLARY GC COLUMN DB-5MS”, product of Agilent Technologies Japan, Ltd., phase: arylene phase with main chain of a siloxane polymer strengthened by adding arylene, inner diameter: 0.25 mm, film thickness: 0.25 μm, length: 30 m).

GC/MS analysis was performed on 100 μg of the measurement sample (either the ultrasonically treated measurement sample or the untreated measurement sample) under the following analysis conditions, and the mass spectrum (horizontal axis: ion mass/of ion charge number, vertical axis: detection intensity) including a peak derived from resin particles was plotted.
Thermal decomposition temperature: heating furnace “600° C.”, interface section “320° C.”
Temperature raising conditions: the temperature was raised from 40° C. to 320° C. at a rate of 28° C./min and kept at 320° C. for 5 minutes.
Carrier gas: Helium (He) gas (linear velocity 36.1 cm/min)
Column head pressure: 49.7 kPa
Injection mode: split injection (split ratio 1:200)
Carrier flow rate: total flow rate “204 mL/min”, column flow rate “1 mL/min”, purge flow rate “3 mL/min”

The mass of the resin particles in the measurement sample was determined based on the mass spectrum (GC/MS method mass spectrum) obtained from the measurement sample by the above GC/MS analysis. Specifically, using a pre-prepared calibration curve, which shows the relationship between the peak area of the GC/MS mass spectrum and the mass of resin particles, the mass of resin particles in the measurement sample was determined from the area of the peak (specifically, any of the peaks of n-butyl methacrylate for the resin particles (A) to (E) and the peaks of methyl methacrylate for the resin particles (F) to (G)) derived from the resin particles measured). More specifically, a mass M_{3R} of the resin particles in the toner particles subjected to the ultrasonic treatment was measured by conducting the GC/MS analysis on the ultrasonically treated measurement sample. The mass M_{1R} of the resin particles in the untreated toner particles was also measured by conducting the GC/MS analysis on the untreated measurement sample. The value obtained by subtracting M_{3R} from M_{1R} was used as the mass M_{2R} of the resin particles detached from the toner mother particles after the ultrasonic treatment. The detachment fraction of the resin particles was calculated by applying M_{1R} and M_{2R} to the following equation.

Detachment fraction of resin particles=100×M_{2R}/M_{1R}

### [Measurement of Detachment Fraction of Silica Particles]

The detachment fraction of silica particles was measured using the ultrasonically treated measurement sample and the untreated measurement sample. Using a tablet molding and compression machine (“BRE-33”, product of MAEKAWA TESTING MACHINE MFG. Co., Ltd.), 1.5 g of the measurement sample (either the ultrasonically treated measurement sample or the untreated measurement sample) was pressure-molded (pressure: 20 MPa, pressurization time: 3 seconds) to produce a cylindrical pellet with a diameter of 30 mm. Fluorescence X-ray analysis was conducted on the obtained pellet under the following conditions to obtain a fluorescence X-ray spectrum (horizontal axis: energy, vertical axis: intensity (number of photons)) including a peak derived from silicon. The X-ray intensity of the peak derived from the measurement element in the obtained fluorescent X-ray spectrum was converted into a percentage content (unit: % by mass) using a pre-prepared calibration curve. Based on the obtained percentage content, the amount of silica particles in the measurement sample was calculated.

### (Conditions for Fluorescent X-Ray Analysis)

Analyzer: scanning X-ray fluorescence analyzer (“ZSX”, product of Rigaku Corporation)
X-ray tube (X-ray source): Rh (rhodium)
Excitation conditions: tube voltage 50 kV, tube current 50 mA
Measurement area (X-ray irradiation range): 30 mm in diameter
Measurement element: Silicon

Specifically, a mass M_{3S} of the silica particles in the toner particles subjected to the ultrasonic treatment was measured by conducting the fluorescence X-ray analysis on the ultrasonically treated measurement sample. The mass M_{1S} of the silica particles in the untreated toner particles was also measured by conducting the fluorescence X-ray analysis on the untreated measurement sample. The value obtained by subtracting M_{3S} from M_{1S} was used as the mass M_{2S} of the silica particles detached from the toner mother particles after the ultrasonic treatment. The detachment fraction of the silica particles was calculated by applying M_{1S} and M_{2S} to the following equation.

Detachment fraction of silica particles=100×M_{2S}/M_{1S}

### [Binder Resin Preparation]

A reaction vessel was charged with 1.0 mol of bisphenol A ethylene oxide adduct (polyoxyethylene (2,2)-2,2-bis(4-hydroxyphenyl) propane), 4.5 mol of terephthalic acid, 0.5 mol of trimellitic anhydride, and 4 g of dibutyltin oxide. After purging the inside of the reaction vessel with a nitrogen atmosphere, the contents of the reaction vessel underwent a polycondensation reaction by holding the contents at 230° C. for 8 hours. Next, the inside of the reaction vessel was depressurized until the internal pressure of the reaction vessel reached 8.3 kPa. This resulted in distillation of the unreacted raw materials remaining in the reaction vessel. The contents of the reaction vessel were then washed and dried. Finally, a binder resin (softening point 120° C.) being a polyester resin, was obtained.

### [Preparation of Toner Mother Particles]

Using an FM mixer (“FM-20B”, product of Nippon Coke & Engineering Co., Ltd.), 100 parts by mass of the binder resin (polyester resin), 5 parts by mass of carbon black (“REGAL (registered Japanese trade mark) 330R”, product of Cabot Corporation) as a colorant, 10 parts by mass of carnauba wax (“CARNAUBA NO. 1”, product of S. Kato & Co.) as a releasing agent, and 3 parts by mass of a quaternary ammonium salt compound (“FCA210PS”, product of FUJIKURA KASEI CO., LTD.) as a charge control agent were mixed. The resulting mixture was then melt-kneaded at 150° C. using a twin-screw extruder (“TEM45”, product of Toshiba Machine Co., Ltd.). The resulting melt-kneaded product was then cooled. After the cooling, the melt-kneaded product was coarsely pulverized using a Feather Mill (registered Japanese trademark) (“MODEL 350×600”, product of Hosokawa Micron Corporation). The coarsely pulverized product was finely pulverized using a pneumatic pulverizer (“JET MILL MODEL IDS-2”, product of Nippon Pneumatic Mfg. Co., Ltd.). The finely pulverized product was classified using an elbow jet classifier (“ELBOW JET MODEL EJ-LABO”, product of Nittetsu Mining Co., Ltd.). Finally, toner mother particles with a volume median diameter (D₅₀) of 8 μm were obtained. Note that the measurement of the volume median diameter used a particle size meter (“COULTER COUNTER MULTISIZER 3”, product of Beckman Coulter, Inc.).

### [Resin Particles Preparation]

Resin particles (A) to (G) used as external additive particles were prepared by the following methods. Table 1 shows the details. In Table 1, “Particle diameter” refers to number average primary particle diameter. “BMA” refers to n-butyl methacrylate. “MM” refers to methyl methacrylate. “DBS” refers to sodium dodecyl benzenesulfonat. “CPC” refers to cetylpyridinium chloride. “BC” refers to stearylbenzyldimethylammonium chloride.

### (Resin Particles (A))

A 1-L four-necked flask, equipped with a stirring vane, a cooling tube, a thermometer, and a nitrogen introduction tube, was charged with 600 parts by mass of ion exchange water, 6 parts by mass of sodium dodecylbenzenesulfonate as an emulsifier (anionic surfactant), 100 parts by mass of n-butyl methacrylate, 20 parts by mass of styrene, 70 parts by mass of divinylbenzene, and 15 parts by mass of a polymerization initiator (benzoyl peroxide) while stirring the flask contents at a rotational speed of 100 rpm.

Subsequently, while stirring the contents of the flask at a rotational speed of 100 rpm, a nitrogen gas was introduced into the flask to create a nitrogen atmosphere. Furthermore, the temperature of the flask contents was raised to 90° C. in the nitrogen atmosphere while the flask contents were being stirred. A reaction (specifically, polymerization reaction) was then caused in the nitrogen atmosphere at a temperature of 90° C. for 150 minutes while stirring the flask contents. This resulted in obtainment of an emulsion containing a reaction product (resin particles (A) with a number average primary particle diameter of 80 nm). The resulting emulsion was then cooled and solid-liquid separated. Next, the solid obtained through solid-liquid separation was thoroughly washed. The solid after washing was then thoroughly dried to obtain a powder of resin particles (A). The resin particles (A) contained crosslinked styrene-methacrylic resin.

### (Resin Particles (B) to (E))

Resin particles (B) to (E) were prepared by the same method as that for preparing the resin particles (A), except that the reaction time was changed as shown in Table 1.

### (Resin Particles (F))

A three-necked flask (reaction vessel), equipped with a nitrogen inlet tube, a reflux tube, and a dropping funnel, was charged with 4.0 parts by mass of cetylpyridinium chloride as an emulsifier (cationic surfactant) and 1230.0 parts by mass of ion-exchange water, and the cationic surfactant was dissolved in the ion exchange water. Separately, a polymerization initiator solution was prepared by mixing 1.5 parts by mass of 2,2′-azobis(2-amidinopropane) dihydrochloride as a polymerization initiator and 15.0 parts by mass of ion exchange water. Next, the reaction vessel was purged with a nitrogen atmosphere and then heated until the temperature of its contents reached 70° C. Next, 16.5 parts by mass of a polymerization initiator solution (1.5 parts by mass of 2,2′-azobis(2-amidinopropane) dihydrochloride and 15.0 parts by mass of ion exchange water), 30.0 parts by mass of styrene, and 270.0 parts by mass of methyl methacrylate were dropped into the reaction vessel over 90 minutes. The contents of the reaction vessel were then allowed to react at 70° C. for 60 minutes. This resulted in obtainment of an emulsion containing a reaction product (resin particles (F) with a number average primary particle diameter of 60 nm). The resulting emulsion was then cooled and solid-liquid separated. Next, the solid obtained through solid-liquid separation was thoroughly washed. The solid after washing was then thoroughly dried to obtain a powder of resin particles (F). The resin particles (F) contained styrene-methacrylic resin.

### (Resin Particles (G))

A powder of resin particles (G) (number average primary particle diameter 120 nm) was prepared by the same method as that for preparing the resin particles (F), except that 1.5 parts by mass of stearyl benzyl dimethylammonium chloride were used as the emulsifier (cationic surfactant) instead of 4.0 parts by mass of cetylpyridinium chloride. The resin particles (G) contained styrene-methacrylic resin.

TABLE 1

| | Particle | BMA | Styrene | DVB | MM | | Reaction |
|---|---|---|---|---|---|---|---|
| Resin | diameter | [parts by | [parts by | [parts by | [parts by | | time |
| particles | [nm] | mass] | mass] | mass] | mass] | Emulsifier | [min] |
| A | 80 | 100 | 20 | 70 | — | DBS | 150 |
| B | 40 | 100 | 20 | 70 | — | DBS | 80 |
| C | 120 | 100 | 20 | 70 | — | DBS | 220 |
| D | 60 | 100 | 20 | 70 | — | DBS | 120 |
| E | 140 | 100 | 20 | 70 | — | DBS | 240 |
| F | 60 | — | 30 | — | 270 | CPC | 60 |
| G | 120 | — | 30 | — | 270 | BC | 60 |

Note that the crosslinked styrene-methacrylic resin contained in each of the resin particles (A) to (E) included a first repeating unit (repeating unit derived from a styrene compound) with a percentage content of 10.5% by mass to all repeating units therein. The crosslinked styrene-methacrylic resin included a second repeating unit (repeating unit derived from (meth)acrylic acid alkyl ester) with a percentage content of 52.6% by mass to all the repeating units therein. The crosslinked styrene-methacrylic resin included a third repeating unit (repeating unit derived from a crosslinking agent) with a percentage content of 36.8% by mass to all the repeating units therein.

The styrene-methacrylic resin contained in each of the resin particles (F) to (G) included a first repeating unit (repeating unit derived from a styrene compound) with a percentage content of 10.0% by mass to all repeating units therein. The styrene-methacrylic resin included a second repeating unit (repeating unit derived from (meth)acrylic acid alkyl ester) with a percentage content of 90.0% by mass to all the repeating units therein.

### <Toner Production>

Toners (T-1) to (T-6) and toners (t-1) to (t-6) shown in Table 2 were prepared by the following methods. The toners (T-1) to (T-6) were used in image forming apparatuses of Examples 1 to 6. The toners (t-1) to (t-6) were used in image forming apparatuses of Comparative Examples 1 to 6. Table 2 also shows the detachment fraction [% by mass] of resin particles or silica particles of each toner measured by the method described above. Note that, in Table 2, “Diameter” refers to the number average primary particle diameter. “Amount” under “Resin particles” or “Silica particles” refers to the content [parts by mass] of resin particles or silica particles contained in 100 parts by mass of the corresponding toner mother particles.

### [Toner (T-1)]

Using an FM mixer (“FM-10B”, product of Nippon Coke & Engineering Co., Ltd.), 100 parts by mass of the toner mother particles, 2.0 parts by mass of silica particles (X) (“CAB-O-SIL (registered Japanese trademark) TG-7120”, product of Cabot Corporation, hydrophobic silica particles, number average primary particle diameter: 20 nm), and 0.8 parts by mass of the resin particles (A) were mixed at a rotational speed of 3500 rpm for 25 minutes (time for the first round of external additive addition). The resulting mixture was sieved through a 200-mesh sieve (opening: 75 μm). The toner (T-1) was thus obtained.

[Toners (T-2) to (T-6) and (t-1) to (t-3)]

Toners (T-2) to (T-6) and (t-1) to (t-3) were prepared by the same method as that for preparing the toner (T-1), except that the types of resin particles and silica particles and the time for the first round of external additive addition were changed as shown in Table 2. Note that silica particles (Y) refers to “AEROSIL (registered Japanese trademark) REA90” (dry silica particles imparted with positive chargeability through surface treatment, number average primary particle diameter: 20 nm) product of Nippon Aerosil Co., Ltd.

[Toner (t-4)]

Using the FM mixer, 100 parts by mass of the toner mother particles and 2.0 parts by mass of the silica particles (X) were mixed at a rotational speed of 3500 rpm for 10 minutes (first round of external additive addition). Next, 0.6 parts by mass of the resin particles (G) were added to the mixture obtained through the first round of the external additive addition and mixed at a rotational speed of 3500 rpm for 25 minutes using the FM mixer (second round of the external additive addition). The mixture obtained through the second round of the external additive addition was sieved with the sieve described above. A toner (t-4) was thus obtained.

[Toner (t-5)]

Using the FM mixer, 100 parts by mass of the toner mother particles and 2.0 parts by mass of the silica particles (X) were mixed at a rotational speed of 3500 rpm for 10 minutes (first round of external additive addition). Next, 0.6 parts by mass of the resin particles (F) were added to the mixture obtained through the first round of the external additive addition and mixed using the FM mixer at a rotational speed of 3500 rpm for 30 minutes (second round of the external additive addition). The mixture obtained through the second round of the external additive addition was sieved using the aforementioned sieve. A toner (t-5) was thus obtained.

[Toner (t-6)]

Using the FM mixer, 100 parts by mass of the toner mother particles and 0.8 parts by mass of the resin particles (A) were mixed at a rotational speed of 3500 rpm for 25 minutes (first round of external additive addition). Next, 2.0 parts by mass of the silica particles (Y) were added to the mixture obtained through the first round of the external additive addition and mixed using the FM mixer at a rotational speed of 3500 rpm for 25 minutes (second round of the external additive addition). The mixture obtained through the second round of the external additive addition was sieved with the aforementioned sieve. A toner (t-6) was thus obtained.

TABLE 2

| | | | | | | | | External additive | |
|---|---|---|---|---|---|---|---|---|---|
| | Resin particles | | | | Silica particles | | | addition | |
| | | | | Detachment | | | Detachment | First | Second |
| | | Diameter | Amount | fraction | | Amount | fraction | round | round |
| Toner | Type | [nm] | [parts] | [%] | Type | [parts] | [%] | [min] | [min] |
| T-1 | A | 80 | 0.8 | 30 | X | 2.0 | 10 | 25 | — |
| T-2 | B | 40 | 0.4 | 22 | X | 2.0 | 20 | 10 | — |
| T-3 | C | 120 | 1.2 | 40 | X | 2.0 | 5 | 35 | — |
| T-4 | D | 60 | 0.6 | 20 | X | 2.0 | 5 | 35 | — |
| t-1 | B | 40 | 0.4 | 16 | X | 2.0 | 10 | 25 | — |
| t-2 | A | 80 | 0.8 | 22 | X | 2.0 | 4 | 40 | — |
| t-3 | E | 140 | 1.4 | 48 | X | 2.0 | 5 | 35 | — |
| T-5 | F | 60 | 0.6 | 20 | X | 2.0 | 5 | 35 | — |
| t-4 | G | 120 | 0.6 | 44 | X | 2.0 | 5 | 10 | 25 |
| t-5 | F | 60 | 0.6 | 17 | X | 2.0 | 7 | 10 | 30 |
| T-6 | A | 80 | 0.8 | 30 | Y | 2.0 | 13 | 25 | — |
| t-6 | A | 80 | 0.8 | 30 | Y | 2.0 | 4 | 25 | 25 |

### <Evaluation>

The toners (T-1) to (T-6) and (t-1) to (t-6) were loaded into the development device of respective evaluation apparatuses described later, which were used as image forming apparatuses in Examples 1 to 6 and Comparative Examples 1 to 6, respectively. A first image formation test and a second image formation test were conducted for each of the image forming apparatuses according to the following method to determine whether image defects (white streaks or uneven image density) has occurred in the formed images. The evaluation results are shown in Table 3.

### [Evaluation Apparatuses]

The evaluation apparatuses used each were a monochrome printer using a non-magnetic one-component developer, “PA-2000” produced by KYOCERA Document Solutions Inc. Each of the evaluation apparatuses included at least a fixing roller and a development device including a restricting blade and a development roller. The restricting blade was a SUS blade. The development roller included a conductive base, a silicone rubber layer covering the surface of the conductive base, and a urethane layer covering the surface of the silicone rubber layer. The restricting blade had a contact pressure against the development roller of 40 N/m. The recording medium used was “MULTIPAPER SUPER WHITE A4” produced by ASKUL Corporation.

### [First Image Formation Test]

The first image formation test was carried out at a temperature of 23° C. and a relative humidity of 50%. A pattern image (printing rate 5%) was intermittently printed on 1500 sheets of the recording media using the evaluation apparatus. The intermittent printing refers to a repetitive process of pattern printing on two consecutive sheets followed by a 300-second interval.

### [Second Image Formation Test]

The second image formation test was carried out at a temperature of 10° C. and a relative humidity of 10%. A pattern image (printing rate 1%) was continuously printed on 1500 sheets of the recording media using the evaluation apparatus.

### [Rating]

Images formed in the first or second image formation test were visually observed every 50th sheet to check for the occurrence of image defects (white streaks or uneven density). If no image defects were recognized even in the image formed last (image formed on the 1500th sheet of the recording medium) during the first or second image formation test, an evaluation target was rated as “A (Pass)”. If image defects were recognized during the first or second image formation test, an evaluation target was rated as “B (Fail)”.

The “Rating” column in Table 3 indicates, within parentheses, the type of image defects that occurred for an evaluation target where image defects were identified. The “Number of sheets” column in Table 3 lists the number of sheets in which image defects were recognized. An evaluation target with “1500” in the “Number of sheets” column indicates that no image defects have been recognized, even in the image formed on the 1500th sheet of the recording medium.

TABLE 3

| | | First image formation test | | Second image formation test | |
|---|---|---|---|---|---|
| | Toner | Rating | Number of sheets | Rating | Number of sheets |
| Example 1 | T-1 | A | 1500 | A | 1500 |
| Example 2 | T-2 | A | 1500 | A | 1500 |
| Example 3 | T-3 | A | 1500 | A | 1500 |
| Example 4 | T-4 | A | 1500 | A | 1500 |
| Comparative Example 1 | t-1 | B (White streaks) | 1400 | A | 1500 |
| Comparative Example 2 | t-2 | B (White streaks) | 1300 | A | 1500 |
| Comparative Example 3 | t-3 | A | 1500 | B (Uneven density) | 1000 |
| Example 5 | T-5 | A | 1500 | A | 1500 |
| Comparative Example 4 | t-4 | A | 1500 | B (Uneven density) | 1300 |
| Comparative Example 5 | t-5 | B (White streaks) | 1400 | A | 1500 |
| Example 6 | T-6 | A | 1500 | A | 1500 |
| Comparative Example 6 | t-6 | B (White streaks) | 1300 | A | 1500 |

As shown in Tables 1 to 3, the image forming apparatuses of Examples 1 to 6 each included a non-magnetic one-component developer, an image bearing member, and a development device that develops an electrostatic latent image formed on the surface of the image bearing member by supplying the non-magnetic one-component developer to the electrostatic latent image. The development device included a development roller that carries the non-magnetic one-component developer and a restricting member that regulates the thickness of a development layer constituted by the non-magnetic one-component developer. The development device was configured to supply the non-magnetic one-component developer to the electrostatic latent image while forming the development layer by allowing the restricting member to contact with the development roller. The non-magnetic one-component developer contained a positively chargeable toner containing toner particles. The toner particles each included a toner mother particle and external additive particles attached to the surface of the toner mother particle. The external additive particles included resin particles and silica particles. When the toner underwent an ultrasonic treatment that involved applying ultrasonic vibration at a frequency of 28 kHz and an output of 100 W for 5 minutes, the resin particles had a detachment fraction of at least 18% by mass and no greater than 42% by mass and the silica particles had a detachment fraction of at least 5% by mass and no greater than 25% by mass. The image forming apparatuses of Examples 1 to 6 each inhibited occurrence of white streaks and uneven image density.

By contrast, in each of the toners (t-1) and (t-5) respectively used in the image forming apparatuses of Comparative Examples 1 and 5, the resin particles had a detachment fraction of less than 18% by mass. It was found that the resin particles in the toners (t-1) and (t-5) were ineffective as spacer particles because they were relatively strongly attached to the toner mother particles. It was found that the silica particles in the toners (t-1) and (t-5) became embedded in the toner mother particles during image formation, rendering the surface of the toner mother particles prone to attach to other elements (particularly, the restricting blade). As a result, it was found that the toner particles in each of the image forming apparatuses of Comparative Examples 1 and 5 were attached to the restricting blade, resulting in white streaks in the formed images.

The toners (t-2) and (t-6) respectively used in the image forming apparatuses of Comparative Examples 2 and 6 contained silica particles with a detachment fraction of less than 5% by mass. It was determined that the toner particles in the toners (t-2) and (t-6) had insufficient flowability due to the inclusion of silica particles with relatively strong adhesion to the toner mother particles. As a result, the image forming apparatuses of Comparative Examples 2 and 6 were unable to consistently maintain the thickness of the developer layer (toner layer) formed on the development roller, leading to the occurrence of white streaks in the formed images.

The toners (t-3) and (t-4) respectively used in the image forming apparatuses of Comparative Examples 3 and 4 contained resin particles with a detachment fraction of greater than 42% by mass. It was found that the resin particles in toners (t-3) and (t-4) were detached from the toner mother particles because they were not attached strongly enough to the toner mother particles. The resin particles detached from the toner mother particles were observed to remain at the contact point between the development roller and the restricting blade. As a result, the image forming apparatuses of Comparative Examples 3 and 4 formed images with uneven image density.

What is claimed is:

1. An image forming apparatus comprising:
a non-magnetic one-component developer;
an image bearing member; and,
a development device that develops an electrostatic latent image formed on the image bearing member by supplying the non-magnetic one-component developer to the electrostatic latent image, wherein
the development device includes a development roller that carries the non-magnetic one-component developer and a restricting member that restricts the thickness of a development layer constituted by the non-magnetic one-component developer,
the development device is configured to supply the non-magnetic one-component developer to the electrostatic latent image while forming the development layer by allowing the restricting member to contact with the development roller,
the non-magnetic one-component developer contains a positively chargeable toner containing toner particles,
the toner particles each include a toner mother particle and external additive particles attached to a surface of the toner mother particle,
the external additive particles include resin particles and silica particles, and
when the toner undergoes an ultrasonic treatment that involves applying ultrasonic vibration at a frequency of 28 kHz and an output of 100 W for 5 minutes, the resin particles have a detachment fraction of at least 18% by mass and no greater than 42% by mass and the silica particles have a detachment fraction of at least 5% by mass and no greater than 25% by mass.

2. The image forming apparatus according to claim 1, wherein
the development roller includes a conductive base, a silicone rubber layer covering a surface of the conductive base, and a urethane layer covering a surface of the silicone rubber layer.

3. The image forming apparatus according to claim 1, wherein
the restricting member is a SUS blade, and
the restricting blade has a contact pressure against the development roller of at least 15 N/m and no greater than 45 N/m.

4. The image forming apparatus according to claim 1, wherein
the resin particles have a content of at least 0.2 parts by mass and no greater than 1.3 parts by mass relative to 100 parts by mass of the toner mother particles.

5. The image forming apparatus according to claim 1, wherein
the resin particles have a number average primary particle diameter of at least 30 nm and no greater than 130 nm.

6. The image forming apparatus according to claim 1, wherein
the resin particles contain cross-linked styrene-(meth)acrylic resin.
